(19) United States
(12) Patent Application Publication
(10) Pub. No.: US 2004/0210939 A1
(43) Pub. Date: Oct. 21, 2004

(54) Apparatus for separating digital broadcasting signal from data transmitted through internet network and method thereof

(76) Inventors: Chang-Won Kim, Suwon-city (KR); Nak-Koo Kim, Sungnam-city (KR); Young-Seop Han, Suwon-city (KR); Myeon-Ki Youn, Incheon-city (KR); Joo-Young Park, Sungnam-city (KR); Seong-Joon Jeon, Yongin-city (KR); Ho-Hyun Park, Yongin-city (KR)

Correspondence Address: ROBERT E. BUSHNELL, 1522 K STREET NW, SUITE 300, WASHINGTON, DC, 20005-1202, US

(21) Appl. No.: 10/811,879

(22) Filed: Mar. 30, 2004

(30) Foreign Application Priority Data
Apr. 1, 2003 (KR) 2003-20609

(51) Int. Cl. H04N 7/173; H04N 7/16; H04B 7/185

(52) U.S. Cl. 725/110; 725/131; 725/112; 725/120; 725/139

(57) ABSTRACT

An apparatus and a method for separating a digital broadcasting signal from data transmitted using an IP network, transmits an IP packet at wire-speed by performing a comparison of an IP address in a hardware scheme without a special memory when separating Internet data and digital broadcasting data (MPEG-TS) in an IP network-based digital broadcasting signal process unit. The digital broadcasting signal separation apparatus includes a reception buffer for receiving the IP packet transmitted through a transmission media; an extractor for copying an IP header from the IP packet outputted from the reception buffer and for extracting the IP header only; a comparator for comparing the address of the IP header extracted from the IP header extractor with the address of the IP header stored in the register; a register for storing a multicast IP address value or a unicast IP address value which includes information on broadcasting channel established by the user; an IP packet path processing unit for selecting an IP packet path according to the result value of the comparison outputted from the comparator; a transmission buffer for transmitting the IP packet in order to return the IP packet from the IP packet path processing unit to the computer, in case that the result value of the comparison of the comparator is determined to be an IP address corresponding to normal Internet data; and an MPEG-TS processing unit for processing the IP packet outputted from the IP packet path processing unit, in case that the result value of the comparison of the comparator is determined to be an IP address corresponding to the digital broadcasting signal.

### CLAIM OF PRIORITY

This application makes reference to, incorporates the same herein, and claims all benefits accruing under 35 U.S.C. §119 from my application for APPARATUS FOR SEPARATING DIGITAL BROADCASTING SIGNAL FROM DATA THROUGH IP NETWORK AND METHOD THEREOF filed with the Korean Industrial Property Office on 1 Apr. 2003 and there duly assigned Serial No.2003-20609.

### BACKGROUND OF THE INVENTION

1. Field of the Invention

The present invention relates to a digital broadcasting service, and more specifically, to an apparatus and a method for separating a digital broadcasting signal from data transmitted using an Internet network which transmits IP (Internet protocol) packet in a wire-speed by performing a comparison of an IP address in a hardware scheme without a special memory when separating Internet data and digital broadcasting signal among signals being serviced through an IP-based Internet network.

2. Description of the Related Art

Currently, a transmission mode to transmit a digital broadcasting signal to a subscriber in a real time is divided into a transmission mode using an Asynchronous Transfer Mode (referred to as ATM, hereinafter) network and a transmission mode using an IP network.

Firstly, the transmission mode using the ATM network will be described as follows. FIG. 1 is a view showing a block diagram of a processing unit for serving a digital broadcasting signal using an ATM network in the art. Referring to FIG. 1, the processing unit includes a transmission media 10 such as xDSL (x-Digital Subscriber Line), optic or cable modem, and a set-top box 20 which receives a digital signal in a form of Moving Picture Experts Group (referred to as an MPEG, hereinafter) transmitted from the transmission media 10, converts the digital signal to an analog signal with which an analog television set can display a picture, and converts a compressed MPEG signal to a standard picture signal by decompressing the signal.

The set-top box 20 includes an ATM interface 21, an ATM MPEG 17 (referred to as ‘MPEG-N’) streamer 22, an MPEG decoder 23, a Digital/Analog Converter (referred to as a DAC) 24, and a controller 25.

The processing procedure of the digital broadcasting signal transmitted through the set-top box is as follows. At first, when the ATM signal is received to the transmission media 10 through the ATM network 10, the signal is interfaced in the ATM interface 21 so that the digital broadcasting signal is outputted to the ATM MPEG-N streamer 22 and the Internet data is outputted to a computer through the controller 25.

After the digital broadcasting signal is divided into its corresponding transmission units (MPEG-1, 2, 3, 4 and 7) in the ATM MEPG-N streamer 22, the signal is decompressed by the MPEG decoder 23, converted to an analog signal by the DAC 24 and transmitted to a corresponding port of a television set.

Accordingly, a user can freely select the digital broadcasting signal transmitted from the broadcasting channel server and watch it on TV (television).

However, the ATM network-based digital broadcasting service is provided only through the ATM network. ATM equipment is expensive and disadvantageous economically in consideration of the current trend that the price of the IP network is reduced more and more.

Considering that Quality of Service (QoS) considered as a problem in the current IP network is solved to some extent and the network is entirely evolving into IP network, there is a necessity for standardizing the transmission equipment interface of the set-top box into the IP interface.

Hereinafter, a processing unit for digital broadcasting of a conventional IP network-based set-top box will be explained.

FIG. 2 is a view showing a block diagram of an apparatus for processing a digital broadcasting signal using an IP network in the art.

Referring to FIG. 2, the IP network-based set-top box 30 includes a Queue 31 for storing the IP packet transmitted from the IP network temporarily and outputting the IP packet sequentially; a memory controller 32 for processing data, Start Of Packet (SOP) and End Of Packet (EOP) signals outputted from the Queue 31; a memory 33 for storing data transmitted from the memory controller 32; an IP header 34 extracted from the IP packet outputted from the memory controller 32; a controller interface 35 for setting and transmitting a broadcasting IP address assigned by a user; a register 36 for storing the set IP address transmitted through the controller interface 35; an exclusive OR gate 37 which compares the IP address stored in the register 36 and the IP header 34, and outputs “0” signal if the IP address is identical with the EP header and “1” signal if not identical; and a Queue 38 for outputting the IP packet stored in the memory 33 to the corresponding output according to the signal outputted from the exclusive OR gate 37.

However, in case of the IP network-based set-top box constructed like that, since the IP packet is first stored in the memory 33 as soon as it is received and it is transmitted one by one from the memory 33 if the address of the IP packet is identical with the IP address of the corresponding digital broadcasting service, a delay is generated necessarily in packet transmission.

Since the received IP packet is determined whether the packet is for broadcasting or not after the packet is first stored in the memory and the IP header is extracted, there occurs a problem that it is not possible to transmit the IP packet at a wire-speed.

The wire-speed means to transmit the IP packet at the same speed with the processing speed of the data flowing on a line. That is, it means to process the IP packet in real-time without any delay.

### SUMMARY OF THE INVENTION

Therefore, the present invention has been made in view of the above and other problems, and it is an object of the present invention to provide an apparatus and a method for separating a digital broadcasting signal from data transmitted using an IP network which transmits an IP packet at a wire-speed by performing a comparison of an IP address in a hardware scheme without a special memory when separating Internet data and digital broadcasting data (MPEG-TS) in an IP network-based digital broadcasting signal process unit.

It is another object to provide the extraction of a digital broadcasting signal from an IP network with ease without using an expensive network processor (for example, ATM interface) in an apparatus capable of receiving a digital broadcasting signal through an Internet network.

It is yet another object to provide for a user to receive broadcasting service more rapidly by extracting directly an IP header of an incoming IP packet in a hardware scheme without storing the IP packet in a special memory.

It is still another object to provide an apparatus and a method for separating a digital broadcasting signal from data transmitted using an IP network that is more efficient and easier to implement.

In accordance with an aspect of the present invention, there is provided an apparatus for separating a digital broadcasting signal from data transmitted using an Internet network, including: a transmission media for transmitting signals transmitted from a server providing a digital broadcasting service and an Internet provider server to a subscriber; a set-top box for separating data received through the transmission media into digital broadcasting data and Internet data and outputting both data to corresponding units; a television set for receiving the digital broadcasting data outputted from the set-top box separately and processing the data; and a computer for receiving the Internet data outputted from the set-top box separately and processing the data, wherein the set-top box compares an IP address of a received IP packet with a broadcasting IP address assigned previously by a user, and processing the IP packet in an MPEG-N TS processing unit when the IP packet is determined as the broadcasting IP address, and outputting the IP packet to a computer directly when the IP packet is determined not to be the broadcasting IP address assigned previously.

Preferably, the set-top box includes a reception buffer for receiving the IP packet; an IP header extractor for extracting an IP header from the IP packet outputted from the reception buffer; a comparator for comparing the address of the IP header extracted from the IP header extractor with the IP address assigned previously by the user; a register for storing the broadcasting IP address value set by the user; an IP packet path processing unit for selecting an IP packet path according to a result value of the comparison outputted from the comparator; a transmission buffer for transmitting the IP packet in order to return the IP packet from the IP packet path processing unit to the computer, in case that the result value of the comparison is determined to be the IP address corresponding to general Internet data; and an MPEG-TS processing unit for processing the IP packet outputted from the IP packet path processing unit, in case that the result value of the comparison of the comparator is determined to be an IP address corresponding to a digital broadcasting signal.

In accordance with another aspect of the present invention, there is provided a method for separating a digital broadcasting signal from data transmitted using an Internet network, including the steps of: receiving an Internet Protocol (IP) packet by a buffer; copying an IP header from the received IP packet and extracting the IP header; comparing the extracted IP header (IP address) with a broadcasting IP address assigned previously by a user; outputting the IP packet to a Moving Picture Experts Group-N Transport Stream (MPEG-N TS) processing unit, in case that the extracted IP header is identical with the broadcasting IP address; and outputting the IP packet to a computer, in. case that the extracted IP header is not identical with a broadcasting IP address.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view showing a block diagram of a processing unit for serving a digital broadcasting signal using an ATM network using an ATM network in the art;

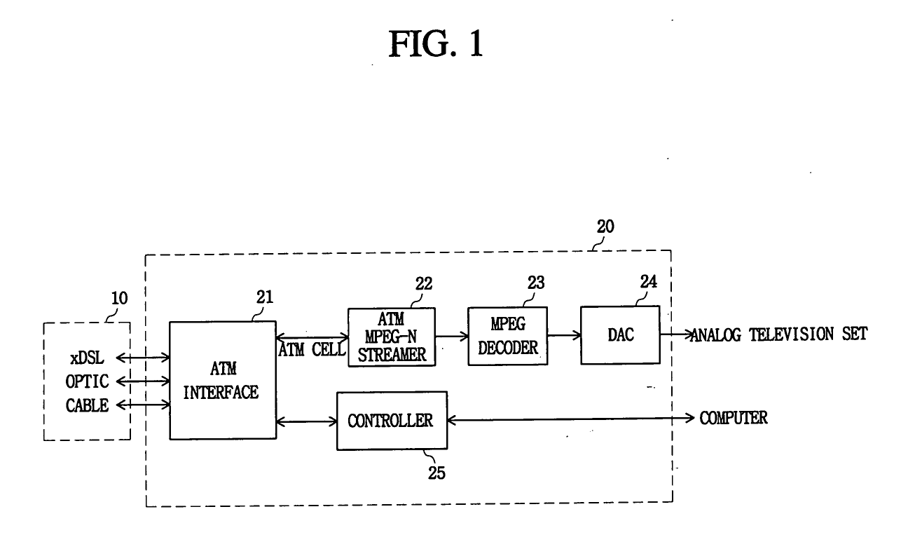

FIG. 2 is a view showing a block diagram of an apparatus for processing a digital broadcasting signal using an IP network in the art;

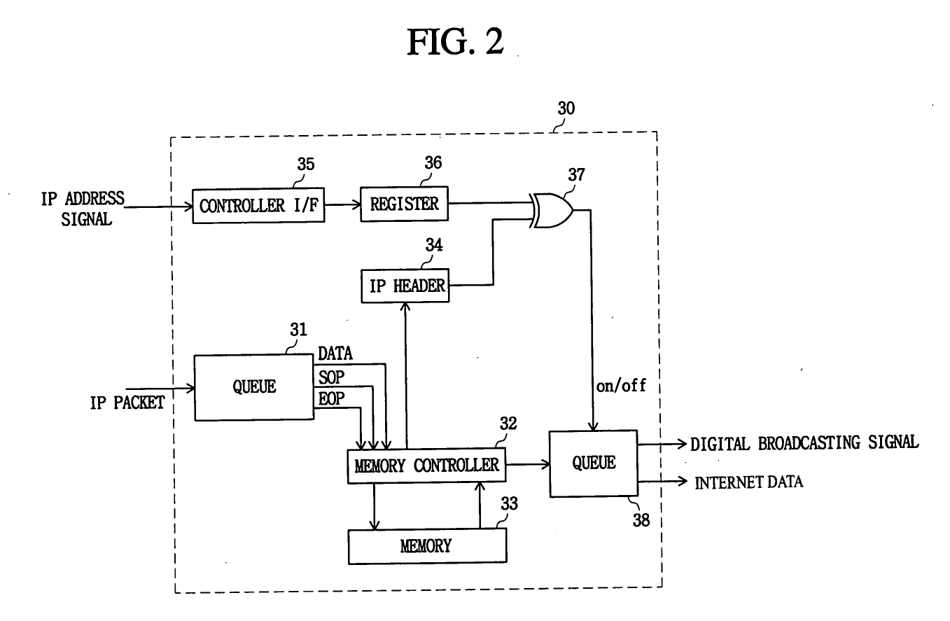

FIG. 3 is a view showing a block diagram of an apparatus for separating a digital broadcasting signal and Internet data from each other at a rapid speed in a digital broadcasting service system using an IP network in accordance with the present invention;

FIG. 4 is a view showing a procedure for performing a comparison of IP address on the basis of a protocol stack in accordance with the present invention;

FIG. 5 is a view showing a block diagram of a digital broadcasting signal separation unit for embodying the present invention;

FIG. 6 is a view showing a block diagram of a unit for separating a digital broadcasting signal and Internet data in accordance with a preferred embodiment of the present invention;

FIG. 7 is a flow chart showing a method for separating the digital broadcasting signal and the Internet data in accordance with a preferred embodiment of the present invention; and

FIG. 8 shows an example of a computer including a computer-readable medium having computer-executable instructions for performing a method of the present invention.

### DETAILED DESCRIPTION OF THE PREFERRED EMBODIMENTS

Now, preferred embodiments of the present invention will be described in detail with reference to the annexed drawings in order that those skilled in the art can embody the present invention with ease.

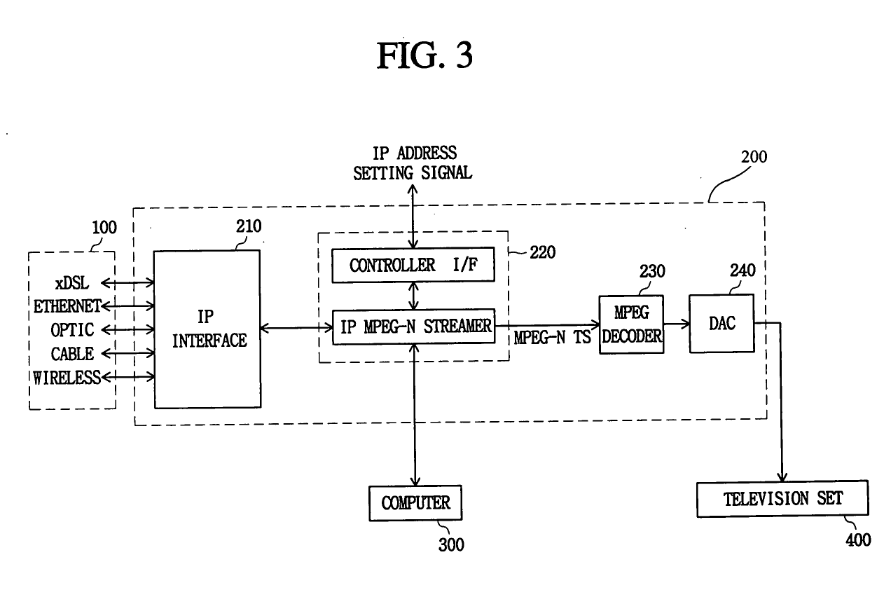

FIG. 3 is a view showing a block diagram of an apparatus for separating a digital broadcasting signal and Internet data from each other at a rapid speed in a digital broadcasting service system using an IP network in accordance with the present invention.

Referring to FIG. 3, a set-top box for separating a digital broadcasting signal and Internet data includes a transmission media 100 such as xDSL, Ethernet, optic, cable modem and wireless LAN (Local Area Network) for transmitting a public digital broadcasting stream provided from a broadcasting station server and Internet data provided from an Internet Service Provider; and a set-top box 200 for separating the digital broadcasting stream and the Internet data transmitted through the transmission media 100 from each other and transmitting them to the corresponding outputs (for example, a television set 400 or a computer 300).

The set-top box 200 includes an IP interface 210 for interfacing data transmitted through an IP network; a data separator 220 for separating the Internet data and the digital broadcasting signal; an MPEG decoder 230 for decompressing the compressed digital broadcasting signal in a form of MPEG and converting it to a signal which can be processed in the television set 400; and a DAC (Digital/Analog Converter) 240 for converting the digital broadcasting signal outputted from the MPEG decoder 230 to an analog broadcasting signal and outputting it.

In case that the television set 400 is a digital television set, the DAC 240 is not needed in the set-top box 200.

Herein, an analog television set used currently is explained as an example.

Hereinafter, a data separation procedure and data separator 220 of a characteristic of the present invention will be explained in detail, wherein the digital broadcasting signal and the Internet data are separately processed.

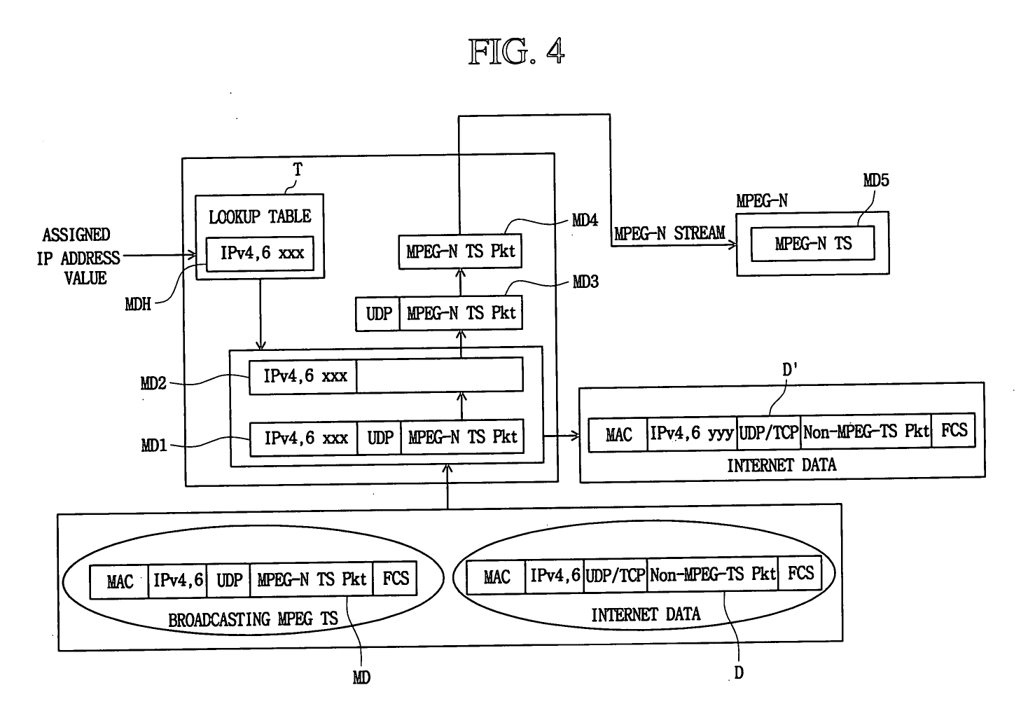

FIG. 4 is a view showing a procedure for performing a comparison of IP address on the basis of a protocol stack in accordance with the present invention.

Referring to FIG. 4, when a broadcasting MPEG TS (MD) and Internet data (D) are inputted to a set-top box 200 through a transmission media 100, they are divided into a digital broadcasting signal packet MD1 and an Internet data packet D′ in the data separator 220 of the set-top box 200.

An IP header MD2 of the digital broadcasting signal packet MD1 is compared with an IP address value MDH which is stored in a look up table T and assigned by a user. Here, when the IP header is identical with the assigned address value of the IP address, the IP header is removed and a User Datagram Protocol (UDP) field and a payload MD3 remain.

When an MPEG-N stream corresponding to a real payload MD4 remains after the UDP field is removed from the remaining UDP field and the payload MD3 is restored to an MPEG stream transmission unit (TS) MD5, it is outputted to the MPEG decoder 230 and decompressed, and converted to an analog signal in the DAC 240 and transmitted to the television set 400.

Hereinafter, a digital broadcasting signal separation unit for embodying the data processing procedure as described above will be explained.

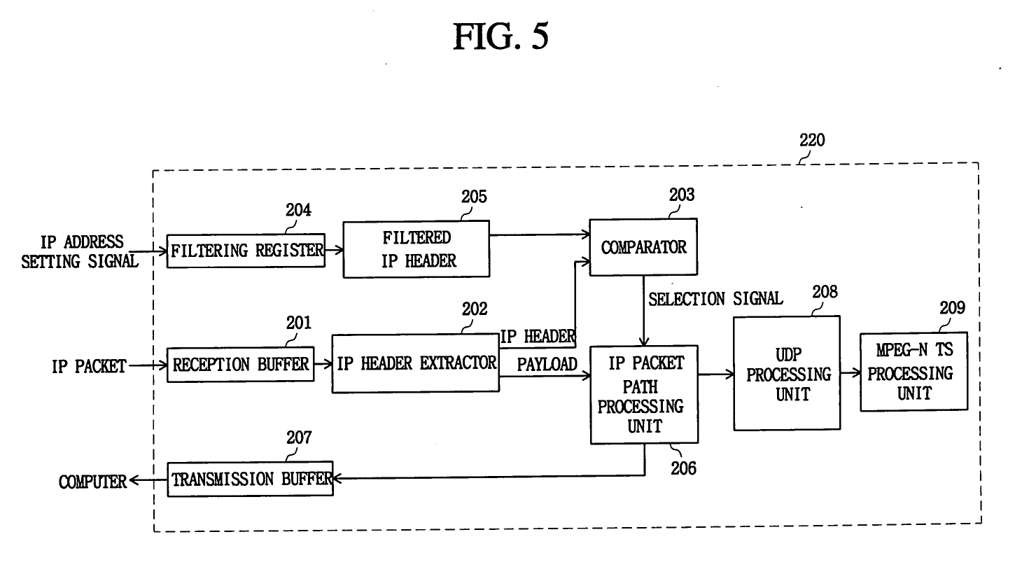

FIG. 5 is a view showing a block diagram of a digital broadcasting signal separation unit for embodying the present invention.

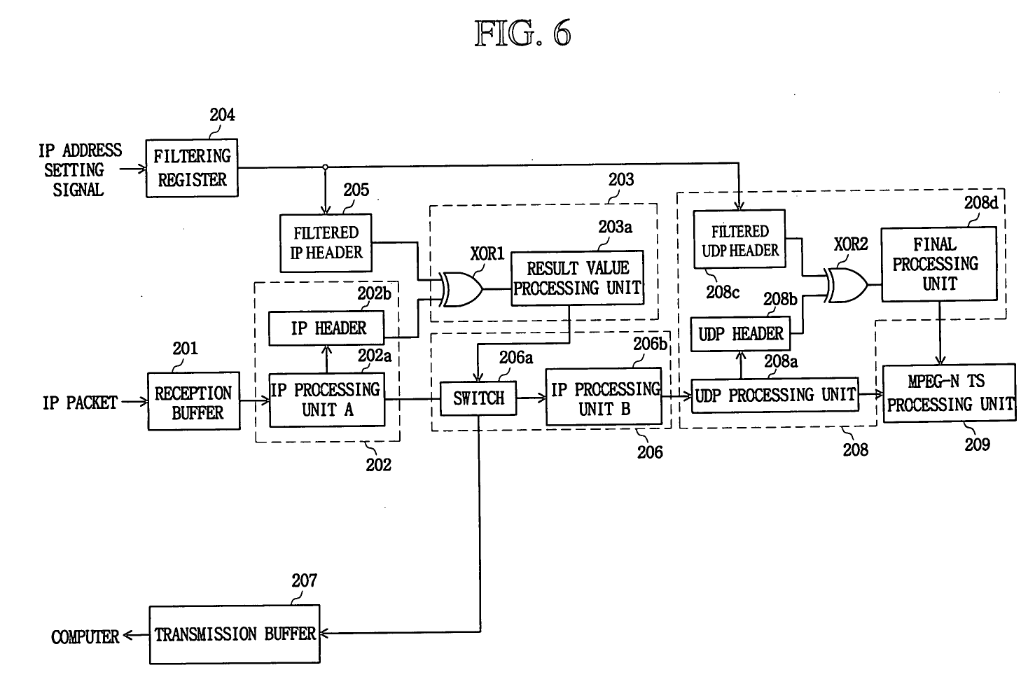

FIG. 6 is a view showing a block diagram of a unit for separating a digital broadcasting signal and Internet data in accordance with a preferred embodiment of the present invention.

Referring to FIGS. 5 and 6, the digital broadcasting signal separation unit has an IP processing unit A 202a to extract an IP header from an IP packet. An IP header 202b and a filtered IP header 205 are compared in an exclusive OR gate XOR1.

The digital broadcasting signal separation unit includes a reception buffer 201 for receiving an IP packet transmitted through a transmission media 100; an IP header extractor 202 for copying an IP header from the IP packet outputted from the reception buffer 201 and extracting the header only; a register 204 for storing a multicast IP address value or a unicast IP address value including information on a broadcasting channel established by users; a comparator 203 for comparing an address of the IP header 202b extracted from the IP header extractor 202 and an address of the IP header 205 stored in the register 204; an IP packet path processing unit 206 for selecting an IP packet path according to a result value of the comparison outputted from the comparator 203; a transmission buffer 207 for transmitting the IP packet in order to return the IP packet to the computer from the IP packet path processing unit 206, in case that the result value of the comparison in the comparator 203 is determined to be an IP address corresponding to normal Internet data; and an MPEG-N TS processing unit 209 for processing the IP packet outputted from the IP packet path processing unit 206, in case that the result value of the comparison in the comparator 203 is determined to be an IP address corresponding to a digital broadcasting signal.

Here, when it is required that a UDP port filtering function is added in order to receive data more stably, it is possible to install a UDP (User Datagram Protocol) processing unit 208 between the IP packet path processing unit 206 and the MPEG-N TS (MPEG-TS) processing unit 209 so as to filter a UDP field of the IP packet by comparing the UDP field with a UDP port assigned by the user.

Hereinafter, a detailed construction of a digital broadcasting signal separation unit is explained.

Referring to FIG. 6, the digital broadcasting signal separation unit has an IP processing unit A 202a to extract an IP header from the IP packet. The IP header 202b and the filtered IP header 205 are compared in an exclusive OR gate XOR1. Here, the method of how the filtered IP header 205 and an IP header 202b of an incoming IP packet are compared in the exclusive OR gate XOR1 is described in Table 1.

TABLE 1

| Filtered IP header | Incoming IP header | Comparison result |
|---|---|---|
| yyy.yy1.y1.x | xxx.yy0.yy0.x00 | Outputting value ‘1’, |
| | | returning it to computer |
| yyy.yy1.y1.x | xxx.yy0.yy0.x00 | Outputting value ‘1’, |
| | | returning it to computer |
| xxx.yy0.yy0.x00 | xxx.yy0.yy0.x00 | Outputting the identical |
| | | value ‘0’ |
| yyy.yy1.y1.x | xxx.yy0.yy0.x00 | Outputting value ‘1’, |
| | | returning it to computer |

For example, in case that a user wishes to watch a Korean Broadcasting system 1 (referred to as an KBS 1, hereinafter) (239.0.1.1), an address part of the IP packet is encapsulated into the multicast IP address (239.0.1.1) and then the broadcasting signal is transmitted from the KBS 1. The IP packet is transmitted to each set-top box through the Internet network. Since the 239.0.1.1 has been already registered at the filtered IP header 205 in the set-top box, the output value of the exclusive OR gate XOR1 becomes 0.0.0.0.

Accordingly, a result value processing unit 203a outputs a switching signal to a switch 206a in order to process the current IP packet as the digital broadcasting signal. Therefore, the IP packet outputted from the IP processing unit A 202a is passed to an IP processing unit B 206b through the switch 206a. Then the IP header of the IP packet is removed in the IP processing unit B 206b and the remaining part of the IP packet is outputted to the UDP processing unit 208.

Here, the control point of the result value processing unit 203a is matched with the point that the IP packet is transmitted to the switch 206a from the IP processing unit A 202a.

On the other hand, in case that the IP header of the current incoming packet is not identical with the IP address assigned by users as a result of the comparison, the exclusive OR gate XOR1 outputs a value including ‘1’ instead of ‘0.0.0.0’. Therefore, the result value processing unit 203a outputs a switching signal to the switch 206a so as to process the current IP packet as the Internet data.

Accordingly, the IP packet outputted from the IP processing unit A 202a is transmitted to the transmission buffer 207 from the switch 206a and processed in the computer 300.

On the other hand, when the UDP processing unit 208 receives from the IP processing unit B 206b a packet whose IP header is removed, the UDP processing unit 208a extracts the UDP header 208b and compares it with the UDP header 208c stored in the filtering register 204.

Here, the values to be compared are port numbers recorded on the UDP header. In case that the port number (that is, filtered UDP header) assigned previously by the user is identical with the porter number recorded on the current incoming UDP header, the exclusive OR gate XOR2 outputs ‘0, and determines that data is normally received in the final processing unit 208d without any loss. So, the packet outputted from the UDP processing unit 208a without the UDP header is transmitted to the MPEG-N TS processing unit 209 as an effective signal so as to be processed in it.

However, in case that the port number (that is, filtered UDP header) assigned previously by the user is not identical with the port number recorded on the current incoming UDP header, the exclusive OR gate XOR2 outputs ‘1, and the final processing unit 208d determines that data is not received abnormally. Therefore, the final processing unit outputs signal ‘discard’ (discarding data) for the packet received.

Hereinafter, the method for separating the digital broadcasting signal and the Internet data will be explained.

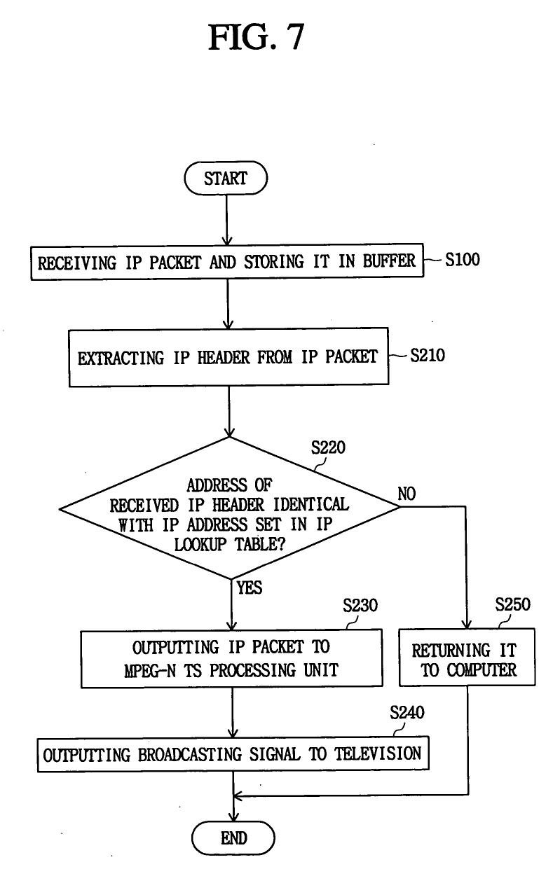

FIG. 7 is a flow chart showing a method for separating a digital broadcasting signal and Internet data in accordance with a preferred embodiment of the present invention.

Referring to FIG. 7, the method for separating the digital broadcasting signal and the Internet data includes a step of receiving an IP packet through a transmission media and storing the received IP packet into a buffer (S100).

When the IP packet extracts an IP header (S210), address information of a separated IP header and an IP address item assigned previously by a user are compared (S220).

If it is determined that an IP address of the IP header separated in the step S220 is identical with a broadcasting IP address (set in an IP lookup table), the corresponding IP packet is outputted to an MPEG-N TS (Moving Picture Experts Group-N Transport Stream) processing unit 209 (S230). An MPEG compression file is decompressed in the MPEG-N TS processing unit 209, converted to an analog signal and outputted to an analog television set (S240).

However, if it is determined that the IP address of the separated IP header is not identical with the broadcasting IP address, the corresponding IP packet is outputted to the computer (S250).

If it is required that a UDP filtering procedure be added, a UDP filtering procedure can be performed before performing S230.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that maybe local or remote to the processing system. The present invention can include the computer-readable medium having stored thereon a data structure including a plurality of fields containing data representing the techniques of the present invention.

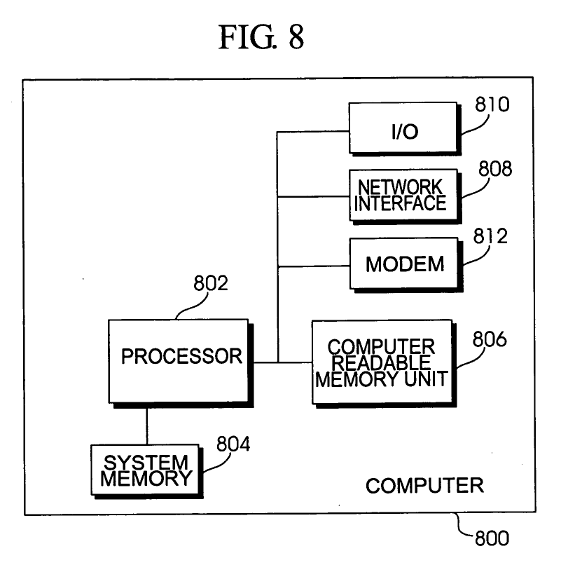

An example of a computer, but not limited to this example of the computer, that can read computer readable media that includes computer-executable instructions of the present invention is shown in FIG. 8. The computer 800 includes a processor 802 that controls the computer 800. The processor 802 uses the system memory 804 and a computer readable memory device 806 that includes certain computer readable recording media. A system bus connects the processor 802 to a network interface 808, modem 812 or other interface that accommodates a connection to another computer or network such as the Internet. The system bus may also include an input and output interface 810 that accommodates connection to a variety of other devices.

As described above, in accordance with the present invention, it is possible to extract a digital broadcasting signal from an IP network with ease without using an expensive network processor (for example, ATM interface) in a set-top box capable of receiving a digital broadcasting signal through an Internet network.

Accordingly, since the Internet data and the digital broadcasting signal can be separated at a wire speed by extracting directly an IP header of an incoming IP packet in a hardware scheme without storing the IP packet in a special memory, a user can receive the broadcasting service is rapidly.

Although the preferred embodiments of the present invention have been disclosed for illustrative purposes, those skilled in the art appreciate that various modifications, additions and substitutions are possible, without departing from the scope and spirit of the invention as disclosed in the accompanying claims.

1. An apparatus for separating a digital broadcasting signal from data transmitted using an Internet network, comprising:
a transmission media for transmitting signals transmitted from a server providing a digital broadcasting service and an Internet provider server to a subscriber;
a set-top box for separating data received through the transmission media into digital broadcasting data and Internet data and outputting both data to corresponding units;
a television set for receiving the digital broadcasting data outputted from said set-top box separately and processing the data; and
a computer for receiving the Internet data outputted from said set-top box separately and processing the data,
with said set-top box comparing an Internet protocol address of a received Internet protocol packet with an broadcasting Internet protocol address assigned previously by a user, and processing the Internet protocol packet in a Moving Picture Experts Group-N transport stream processing unit when the Internet protocol packet is determined as the broadcasting Internet protocol address, and outputting the Internet protocol packet to said computer directly when the Internet protocol packet is determined not to be the broadcasting Internet protocol address assigned previously.

2. The apparatus according to claim 1, wherein said set-top box comprises:
a reception buffer for receiving the Internet protocol packet;
an Internet protocol header extractor for extracting an Internet protocol header from the Internet protocol packet outputted from said reception buffer;
a comparator for comparing the address of the Internet protocol header extracted from said Internet protocol header extractor with the Internet protocol address assigned previously by the user;
a register for storing the broadcasting Internet protocol address value set by the user;
an Internet protocol packet path processing unit for selecting an Internet protocol packet path according to a result value of the comparison outputted from said comparator;
a transmission buffer for transmitting the Internet protocol packet in order to return the Internet protocol packet from said Internet protocol packet path processing unit to the computer, when the result value of the comparison is determined to be the Internet protocol address corresponding to general Internet data; and
said Moving Picture Experts Group-N transport stream processing unit for processing the Internet protocol packet outputted from the Internet protocol packet path processing unit, when the result value of the comparison of the comparator is determined to be an Internet protocol address corresponding to a digital broadcasting signal.

3. The apparatus according to claim 2, wherein said comparator of said set-top box makes a use of an exclusive OR gate.

4. The apparatus according to claim 2, wherein said set-top box further includes a user datagram protocol filtering process unit for performing a port number filtering in order to identify whether data is normally received without any data loss.

5. The apparatus according to claim 4, wherein said user datagram protocol filtering process unit comprises a user datagram protocol processing unit for separating a user datagram protocol header and data part;
an exclusive OR unit for comparing the user datagram protocol header with the filtered user datagram protocol header; and
a final processing unit for determining whether to discard the data or to output the data to a Moving Picture Experts Group-N transport stream processing unit according to an output value of said exclusive OR unit.

6-7. (Cancelled)

8. A method for separating a digital broadcasting signal from data transmitted using an Internet network, comprising the steps of:
receiving an Internet Protocol packet by a buffer;
copying an Internet protocol header from the received Internet protocol packet and extracting the Internet protocol header;
comparing an Internet protocol address of the extracted Internet protocol header with a broadcasting Internet protocol address assigned previously by a user;
outputting the Internet protocol packet to a Moving Picture Experts Group-N transport stream processing unit, when the extracted Internet protocol header is identical with the broadcasting Internet protocol address; and
outputting the Internet protocol packet to a computer, when the extracted Internet protocol header is not identical with a broadcasting Internet protocol address.

9. The method according to claim 8, further comprising the step of establishing at least one broadcasting Internet protocol address to be watched by the user before said step of receiving the Internet Protocol packet by the buffer is performed.

10. The method according to claim 8, wherein said step of outputting the Internet protocol packet to said computer further comprises the step of outputting the Internet protocol packet to the computer through a transmission buffer, when the Internet protocol address of the extracted Internet protocol header is not identical with the broadcasting Internet protocol address.

11. The method according to claim 8, wherein said step of outputting said Internet protocol packet to a Moving Picture Experts Group-N transport stream processing unit further comprises the step of filtering a user datagram protocol.

12. The method according to claim 1 1, wherein said step of filtering a user datagram protocol comprises the steps of:
receiving an Internet protocol packet from which an Internet protocol header is removed;
separating a user datagram protocol header and data of the packet;
comparing a port number recorded on the user datagram protocol header with a port number assigned previously by the user;
outputting the data to the Moving Picture Experts Group-N transport stream processing unit, when the port number recorded on the user datagram protocol header is identical with the port number assigned previously, as it is determined that the data is received normally; and
performing a discard processing, when the port number recorded on the user datagram protocol header is not identical with the port number assigned previously, as it is determined that the data is received abnormally, said discard processing discarding data.

13-14. (Cancelled)

15. The method according to claim 12, further comprising of performing a user datagram protocol filtering procedure before performing said step of outputting the Internet protocol packet to said Moving Picture Experts Group-N transport stream processing unit.

16. An apparatus, comprising:
a first unit transmitting signals transmitted from a server providing a digital broadcasting service and an Internet provider server to a subscriber;
a second unit separating data received through said first unit into digital broadcasting data and Internet data and outputting both data to corresponding units; a third unit receiving the digital broadcasting data outputted from said second unit separately and processing the data; and
a fourth unit receiving the Internet data outputted from said second unit separately and processing the data,
with said second unit comparing an Internet protocol address of a received Internet protocol packet with an broadcasting Internet protocol address assigned previously, and processing the Internet protocol packet in a Moving Picture Experts Group-N transport stream processing unit when the Internet protocol packet is determined as the broadcasting Internet protocol address, and outputting the Internet protocol packet to said fourth unit directly when the Internet protocol packet is determined not to be the broadcasting Internet protocol address assigned previously.

17. (Cancelled)

18. The apparatus according to claim 16, wherein said second unit comprises:
a fifth unit receiving and storing the Internet protocol packet;
an sixth unit extracting an Internet protocol header from the Internet protocol packet outputted from said fifth unit;
a seventh unit comparing the Internet protocol header directly from the extraction from said sixth unit with the Internet protocol address assigned previously;
an eighth unit storing the broadcasting Internet protocol address value set by the user;
a ninth unit selecting an Internet protocol packet path according to a result value of the comparison outputted from said seventh unit; and
a tenth unit transmitting the Internet protocol packet in order to return the Internet protocol packet from said Internet protocol packet path processing unit to said fourth unit, when the result value of the comparison is determined to be the Internet protocol address corresponding to general Internet data.

19. The apparatus according to claim 18, wherein said second unit comprises said Moving Picture Experts Group-N transport stream processing unit for processing the Internet protocol packet outputted from the Internet protocol packet path processing unit, when the result value of the comparison of the comparator is determined to be an Internet protocol address corresponding to a digital broadcasting signal.

20. The apparatus according to claim 19, wherein said seventh unit includes an exclusive OR gate.

21. The apparatus according to claim 20, wherein said second unit further comprises a user datagram protocol filtering process unit for performing a port number filtering in order to identify whether data is normally received without any data loss.

22. The apparatus according to claim 21, wherein said user datagram protocol filtering process unit comprises a user datagram protocol processing unit for separating a user datagram protocol header and data part.

23. The apparatus according to claim 22, wherein said user datagram protocol filtering process unit further comprises an exclusive OR unit for comparing the user datagram protocol header with the filtered user datagram protocol header.

24. The apparatus according to claim 23, wherein said user datagram protocol filtering process unit further comprises a final processing unit for determining whether to discard the data or to output the data to said Moving Picture Experts Group-N transport stream processing unit according to an output value of said exclusive OR unit.

25. A computer-readable medium having computer-executable instructions for performing a method, comprising:
receiving an Internet Protocol packet;
copying an Internet protocol header from the received Internet protocol packet and extracting the Internet protocol header;
comparing an Internet protocol address of the extracted Internet protocol header with a broadcasting Internet protocol address assigned previously by a user;
outputting the Internet protocol packet to a Moving Picture Experts Group-N transport stream processing unit, when the extracted Internet protocol header is identical with the broadcasting Internet protocol address;
outputting the Internet protocol packet to a computer, when the extracted Internet protocol header is not identical with a broadcasting Internet protocol address; and
establishing at least one broadcasting Internet protocol address to be watched by the user before said step of receiving the Internet Protocol packet by the buffer is performed.

26. The computer-readable medium having computer-executable instructions for performing a method of claim 25, wherein:
said step of outputting the Internet protocol packet to said computer further comprises the step of outputting the Internet protocol packet to the computer through a transmission buffer, when the Internet protocol address of the extracted Internet protocol header is not identical with the broadcasting Internet protocol address;
said step of outputting said Internet protocol packet to a Moving Picture Experts Group-N transport stream processing unit further comprises the step of filtering a user datagram protocol; and
said step of filtering a user datagram protocol comprises the steps of:
receiving an Internet protocol packet from which an Internet protocol header is removed;
separating a user datagram protocol header and data of the packet;
comparing a port number recorded on the user datagram protocol header with a port number assigned previously by the user;
outputting the data to the Moving Picture Experts Group-N transport stream processing unit, when the port number recorded on the user datagram protocol header is identical with the port number assigned previously, as it is determined that the data is received normally; and
performing a discard processing, when the port number recorded on the user datagram protocol header is not identical with the port number assigned previously, as it is determined that the data is received abnormally, said discard processing discarding data.

27. (Cancelled)
